(19) United States
(12) Patent Application Publication
(10) Pub. No.: US 2009/0204511 A1
(43) Pub. Date: Aug. 13, 2009

(54) SYSTEM AND METHOD FOR DISTRIBUTING TARGETED CONTENT

(75) Inventor: Justin Chiu Jun Tsang, Central Hong Kong (CN)

Correspondence Address: HESLIN ROTHENBERG FARLEY & MESITI PC, 5 COLUMBIA CIRCLE, ALBANY, NY, 12203, US

(73) Assignee: IMAGIC SYSTEMS LIMITED, CENTRAL, HONG KONG (CN)

(21) Appl. No.: 12/297,551

(22) PCT Filed: Feb. 28, 2007
(86) PCT No.: PCT/CN2007/000626

§ 371 Date: Feb. 20, 2009

(30) Foreign Application Priority Data
Apr. 19, 2006 (HK) 06104687.4
Aug. 25, 2006 (HK) 06109482.0

(51) Int. Cl. G06Q 30/00; G06F 17/30; H04M 1/00

(52) U.S. Cl. 705/27; 707/5; 707/E17.03; 707/104.1; 707/E17.019; 707/E17.114; 455/550.1

(57) ABSTRACT

A system and method for distributing target content, i.e. advertising or promotional material, are disclosed. A user takes a photograph of an image meeting predefined criteria. Image data defining the photograph is extracted and transmitted to a server where the image data is matched with corresponding image data relating to a plurality of pre-stored images. Where a match is found content is transmitted back to the user.

### FIELD OF THE INVENTION

This invention relates to a system and method for distributing target content, and in particular to a system and method for distributing target content to a mobile communications device such as a mobile phone.

### BACKGROUND OF THE INVENTION

With the increasing number of mobile phone users, and the increasing technical capability of mobile phones, mobile phones are increasingly being used for functions beyond traditional voice-to-voice communications. In particular there is a desire on the part of both mobile phone users and also mobile phone network operators, for the provision of additional services.

The provision of targeted content to mobile phone users is seen as a desirable objective. At a simple level this can be achieved for example by sending a mobile phone user text messages, SMS or MMS messages concerning a product or service. Such direct provision of content is, however, very unsophisticated and may be negatively received by the mobile phone user as a form of “junk mail” or “spam”. Furthermore such simplistic techniques do not enable an advertiser to obtain any information as to how well the advertising material is being received.

### PRIOR ART

WO2005/103980 discloses a system in which content can be provided to the mobile phone user upon request of the mobile phone user. In this prior art system the mobile phone user uses his/her mobile phone to take a photograph of an image of interest. That photograph is the sent by MMS messaging to a server where it is matched with a database of stored images. If a match is found, data associated with the image may then be sent to the mobile phone user.

This system has a number of disadvantages. Firstly, because the photographed image is sent by MMS messaging, there may be delays in the system while the image goes through the MMS server. There may also be cost implications to the user if he is charged for sending an MMS message, which may make the system less desirable from the perspective of the mobile phone user.

The system of WO2005/103980 also requires the matching of images, which is difficult to achieve with complete reliability, and may be particularly difficult if the photographed image is taken under different lighting conditions or at a different orientation.

### SUMMARY OF THE INVENTION

According to the present invention there is provided a system for providing data content to a user, comprising: a communications device and a camera, said camera device being capable of taking a photograph of an image and said communications device being capable of processing said photograph to extract image data and to transmit said extracted image data; an image database comprising image data associated with a plurality of different images; a content database comprising data content associated with respective said images; means for receiving extracted image data transmitted from a said communications device and means for matching said extracted image data with image data stored in said image database; and means for transmitting to said communications device data content associated with a respective image when a match between said extracted image data and stored image data is made.

The data content transmitted to the communications device may include data to be displayed on a screen of the communications device. Alternatively (or in addition) the data content may include an address from where data may be obtained by the communications device. In this alternative possibility the data content may include instructions for the communications device to activate a browser program and to obtain data from this address.

The system preferably further comprises a usage database for storing details of users who access the system and the image data transmitted by users. Preferably the system may further comprise means for generating reports from this usage database.

Preferably the system includes means for uploading new image data and new associated content to the image and content databases.

The matching means preferably comprises a software image matching program and wherein associated data is provided to a user in the event of a successful match being found by said program, and wherein an error message is provided to said user in the event of no match being found.

The data transmitted to the communications device may preferably include an option for a user to receive further data at future times.

The communications device may comprise a personal computer that simply receives and image taken by a conventional digital camera and which then processes that image for transmission. Preferably, however, the communications device is a mobile communications device, such as a mobile phone, with an integral camera. In such an embodiment the extracted image data may be transmitted from the mobile phone to the Internet gateway of a mobile phone network and then through the Internet.

The image data stored in the image database preferably corresponds to images printed in print media or other forms of two-dimensional visual media.

In a preferred embodiment of the invention a photographed image is converted to a grayscale image prior to extraction of image data. The image data may comprise data relating to the number of pixels per grayscale frequency.

According to another aspect of the present invention there is provided a method of providing data content to a user, comprising: receiving image data extracted from a photographed image and transmitted by a user from a communications device; comparing the extracted image data with image data stored in an image database; and in the event of an image match being found transmitting to the communications device data content associated with the photographed image.

The data content transmitted to the communications device may include data to be displayed on a screen of said communications device, or alternatively (or in addition) the data content may include an address from where data may be obtained by said communications device. In the latter possibility the data content may further include instructions for the communications device to activate a browser program and to obtain data from the address.

Preferably the method further comprises storing in a usage database details of users transmitting extracted image data and details of the images associated with said transmitted extracted image data. The method may further comprise generating reports from the usage database.

An error message may be delivered to said user in the event that no match is found between the transmitted extracted image data and the image data stored in the image database.

The data transmitted to the communications device may include an option for a user to receive further data at future times.

The extracted image data is preferably transmitted wirelessly. While the communications device may comprise a personal computer that received an image taken by a separate digital camera, preferably the communications device is a mobile communications device, for example a mobile phone, with an integral camera, wherein a photographed image is processed on the mobile phone to extract image data, and wherein extracted image data is transmitted from the mobile phone to the Internet gateway of a mobile phone network and then through the Internet.

According to another aspect of the invention there is provided apparatus for providing data content to users, comprising: means for receiving extracted image data from a user; means for comparing the extracted image data with image data stored in an image database; a content database hosting data content associated with respective images associated with the image data stored in the image database, and means for transmitting to a user data content associated with an image in the event that the extracted image data matches image data in the image database.

Preferably the apparatus further comprises means for uploading new data content to the content database, and/or new image data to the image database.

Preferably the apparatus further comprises a usage database for recording details of users and details of image data received from users.

Preferably the databases are hosted on at least one server. For example the apparatus may comprise a media server for hosting the content database, at least one database server for hosting the image database and the usage database, and an image matching server for performing the step of comparing received extracted image data with image data in the image database. Preferably a second media server and a second image matching server are provided as back up. The at least one database server may preferably comprise two database servers operating as a cluster. Also, the apparatus may further comprise a software download server.

According to a still further aspect the invention also provides a method of obtaining data associated with an image, comprising the steps of: photographing said image; extracting image data from said photograph; transmitting said extracted data by means of a communications device to an image matching server, wherein said server hosts an image database comprising image data associated with a plurality of respective images; and in the event of a match receiving data associated with said image.

Preferably the image data is extracted by firstly converting the photographed image to a grayscale image, and then extracting data relating to the number of pixels per grayscale frequency.

### BRIEF DESCRIPTION OF THE DRAWINGS

Some embodiments of the invention will now be described by way of example and with reference to the accompanying drawings, in which:

FIG. 1 is a schematic overview of a content distribution system according to an embodiment of the invention,

FIG. 2 is a schematic showing how a new content provider may be added to a system according to an embodiment of the invention,

FIG. 3 is a schematic illustrating the dataflow in a system according to an embodiment of the invention,

FIG. 4 is a schematic illustrating a billing and reporting dataflow in an embodiment of the invention,

FIG. 5 is a schematic illustrating the software operations within a mobile device in use of a system according to an embodiment of the invention,

FIG. 6 illustrates a possible physical network infrastructure for implementing an embodiment of the invention,

FIG. 7 shows an example of an image meeting the necessary criteria for matching, and

FIG. 8 is a flowchart illustrating a further embodiment of the invention.

### DETAILED DESCRIPTION OF PREFERRED EMBODIMENTS

As will be seen from the following description the present invention provides a system and method for distributing targeted content to a communications device, eg a mobile telephone, using an image that is provided in traditional media and using the ability of the mobile communications device to take a photograph of the image and to transmit data wirelessly. In the following description reference will be made to a mobile telephone, but it will be understood that the invention can be applied to any mobile communications device provided that the device is capable of operating wirelessly and is capable of taking a photograph and transmitting data. Indeed while it will be understood that the invention is particularly useful where the mobile device communicates wirelessly, the invention could also be applied to fixed-line communication where the extracted data is sent by a fixed-line. For example the photograph could be taken by a digital camera and the image data extraction may be performed on a fixed PC before transmission through a fixed-line communication means to the server.

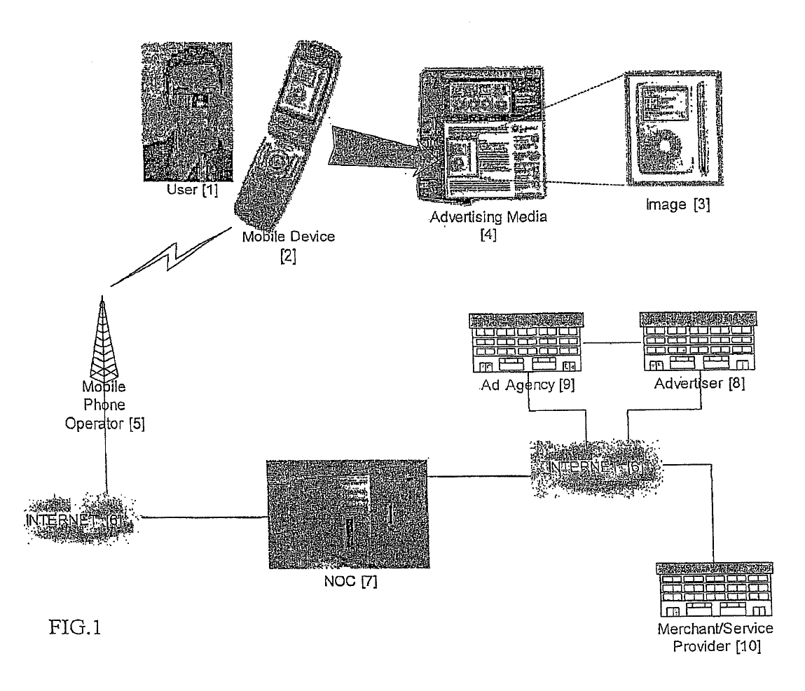

Referring to FIG. 1 an embodiment of a system and method according to the present invention will be described. A user 1 possesses a mobile telephone 2. The mobile telephone 2 is of a type provided with an integral camera and is capable of taking photographs and sending data. The mobile telephone 2 communicates through a mobile phone operator 5 and can connect through the mobile phone operator 5 to the Internet 6.

In the embodiment of FIG. 1 advertising material 4 is provided in traditional advertising media. The advertising media may be a print advertisement in a magazine or newspaper, may be billboard or a poster, may be a flyer or any other form of two-dimensional advertisement that provides text and/or images to the public. In addition to print media, for example, the image could be presented on a video screen or as part of a television advertisement. Within the advertising material 4 there is provided an image 3. The image 3 is formed in accordance with predefined criteria that will be described below.

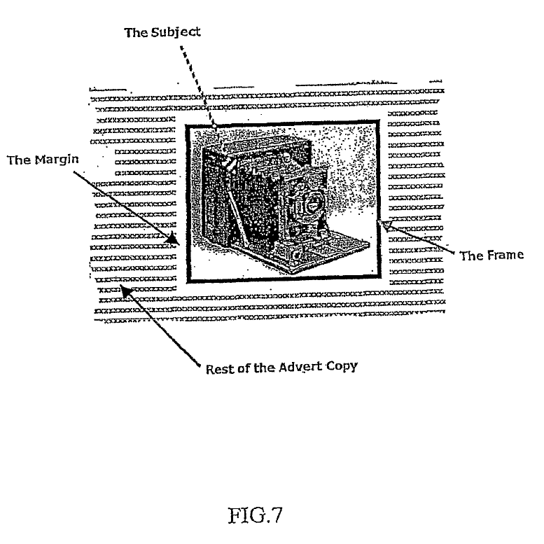

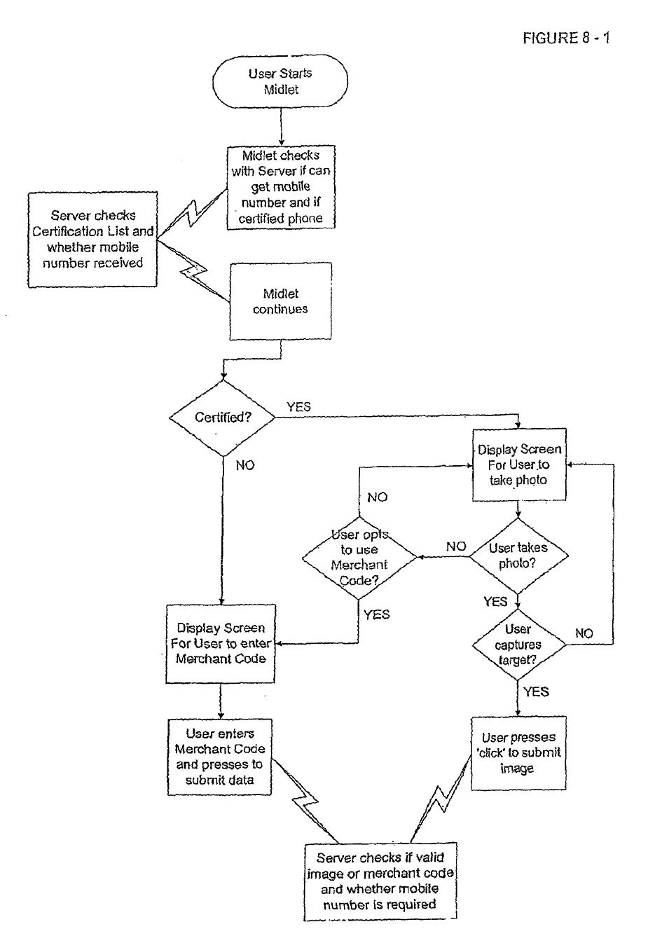

In particular the image should be surrounded by a frame (the size of which will depend upon the size of the image), and clear margins should be provided between the frame and the surrounding advertising copy. FIG. 7 illustrates an image of a camera surrounded by a frame, which in turn is surrounded by other advertising copy. Generally the size of the image is not too important, however it should be something that can be easily photographed by the mobile phone user at an appropriate distance. Thus for print media (newspapers, magazines, etc) the size of the shortest side of the frame might be for example between 30 mm and 100 mm. To go below 30 mm makes capture of the photograph unreliable and above 100 mm the camera phone would have to be held beyond normal reading distance. Another factor to consider is the aspect ratio (the longest side of the frame to the shortest side), which should not be more than 3 to 1.

The frame should have a straight outside edge; curved corners or wavy lines are not suitable (though the inner edge of the frame may be any shape). For the size of picture indicated above, the frame should be 1.0 mm minimum in thickness; 2.0 mm to 3.0 mm works the best. The frame could be coloured depending upon the background colour of the advertisement. For a dark coloured advertisement a light coloured frame may be used and for a light coloured advertisement use a dark coloured frame may be used.

The margin (i.e. the area between the frame and any other portion of the advertising copy) should be the following minima:

| Frame Size | Minimum Margin Size |
|---|---|
| 30.0 mm | 2.0 mm |
| 50.0 mm | 3.0 mm |
| 70.0 mm | 4.0 mm |
| 100.0 mm | 6.0 mm |

The margin should be what is termed “silent space”, i.e. plain colour, not speckled or striped, and no other graphical decoration is permitted within the margin area. In addition no other portion of the advertisement should protrude across the margin or frame.

The image itself should preferably not be a ‘flat image’, i.e. should not have a large expanse of a single colour but instead have a good range of different pixel luminance. This is best achieved by using a real photograph as the subject rather than a stark vector based graphic. Things to avoid for best results are: lots of plain background colour within the frame and a small subject image; large amounts of text which renders the image difficult to distinguish from others with large amounts of text; any squares or boxes within the frame which may themselves be mistaken as the target image; barcodes.

A processed version of image 3 (the nature of the processing will be described below) is stored at a network operating centre 7 and associated with the processed image 3 is content that may be provided by an advertising agency 9, an advertiser 8 or a retailer or service provider 10. While the associated content may also be provided at the network operating center 7, preferably associated with each image stored in the network operating center are details of addresses, eg URL addresses, of an advertising agency 9, advertiser 8 or retailer or service provider 10 where the content may be obtained. In the embodiment shown in FIG. 1 the advertising material 4 relates to a digital music player and the image 3 is a photograph of the music player itself. The content associated with that image 3 may be technical details of that digital music player, reviews, price information, details of retailers and/or other information relevant to the digital music player.

In the embodiment of FIG. 1, if a user 1 is interested in obtaining more information of the digital music player featured in the advertising material 4, the user 1 will use his mobile phone 2 to take a photograph of the image 3. The image 3 may then be stored on the mobile phone 2 and will be analysed by software operating on the mobile phone to confirm that the image meets the predefined criteria (as discussed above) and is an image of a suitable type to be matched with associated content. If the software determines that the image does not meet the necessary criteria, the user will be advised and the user may retake the photograph (for example if the frame has not been fully captured in the stored photograph).

If the software on the mobile phone determines that the captured image does meet the criteria for matching, the photograph is then processed by the software loaded on the mobile phone to extract image data. The extracted image data may take a number of forms but preferably the photograph is first converted to a grayscale image, and then data concerning the number of pixels per grayscale frequency is obtained and this data is stored as a binary file. Other forms of data extraction may be employed, however, and what is important is simply that data defining an image may be extracted from a photograph, the image defining data being easily searchable for comparison with stored image data, and preferably being a relatively small data file for ease of transmission. In this specification the binary file containing this extracted data will be referred to as the extracted image data.

The extracted image data is then transmitted to the network operating center 7 through the Internet gateway of the mobile phone operator 5 and the public Internet 6. At the network operating center 7 image matching software compares the extracted image data 3 with a database of stored image data until a match is found. Upon finding a match and an associated URL address, the network operating center 7 instructs the mobile device 2 to launch its browser software and go to the associated URL address and download the content associated with the extracted image data. The user 1 is then able to browse the associated content at their leisure.

It is important to note that the photographed image itself is not transmitted; only the extracted image data. This is advantageous because the extracted image data file may be relatively small and thus easy and fast to transmit. The extracted data may be sent directly to the network operating center, ie there is no need to use MMS messaging and the delays associated with the MMS server. It is also important to note that the matching is not between two images directly, but between the image data extracted from a photographed image and a database of image data extracted from and associated with respective images.

It will be understood that the network operating center 7 is also capable of logging and recording all accesses by users of the system. This information may include details of the images for which extracted data is sent, details of the locations of users, times when the system was accessed and geographic and demographic information relating to the users and their responses to particular advertising campaigns.

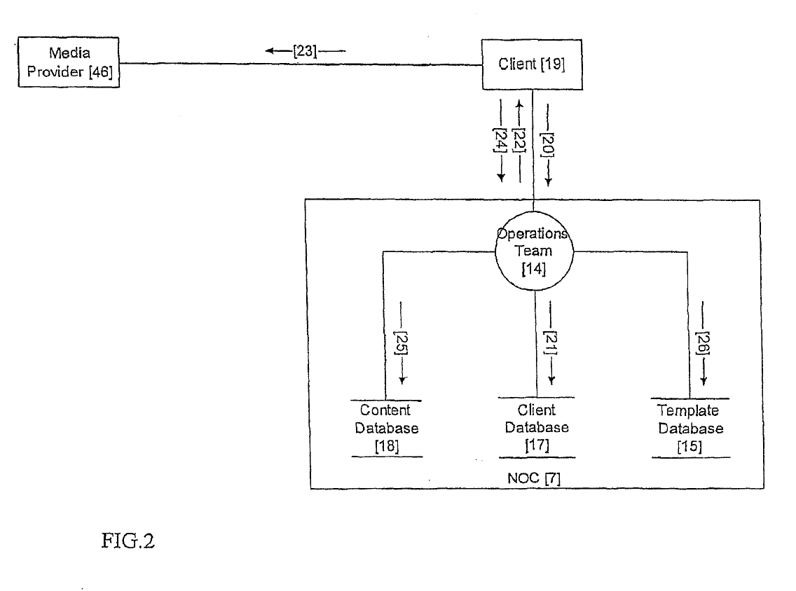

FIG. 2 shows schematically how a new client 19 may be added to the system. In this description the advertising agency 9, advertiser 8 and retailer or service provider 10 of FIG. 1 are all examples of a client that wishes to provide content to users 1. When a new client 19 wishes to be added to the system details of the client 19 are provided to an operations team 14 (the functions of the operations team 14 may be performed by human staff and/or software means) at the network operating center 7 as shown by dataflow 20. Details of the client 19 are then provided to a client database 17 (dataflow 21). Operations team 14 will then send to the client 19 details of appropriate standards, requirements and templates (dataflow 22). Client 19 will then arrange with media provider 46 (dataflow 23) for publication of desired advertising material including within that material a defined image 3 (FIG. 1). The client 19 will also send (dataflow 24) to the operations team 14 a copy of the defined image 3 together with either the associated content to be provided with that image (if the content is to be stored at the network operating center) or the URL address(es) from where the content may be obtained. In turn the operations team 14 will pass the content or the URL address(es) to content database 18 (dataflow 25). The image 3 will be processed in the same manner that a captured photograph is processed by the software on the mobile phone, ie it is converted to a grayscale image and image data is extracted as described above, and the image data is then passed to an image database 15 (dataflow 26). Thus the image database 15 does not necessarily contain the images themselves, though it may do, but contains at least the extracted image data that is associated with each image. A cross-table will also be provided to link the image data in database 15 with the content/address(es) in database 18.

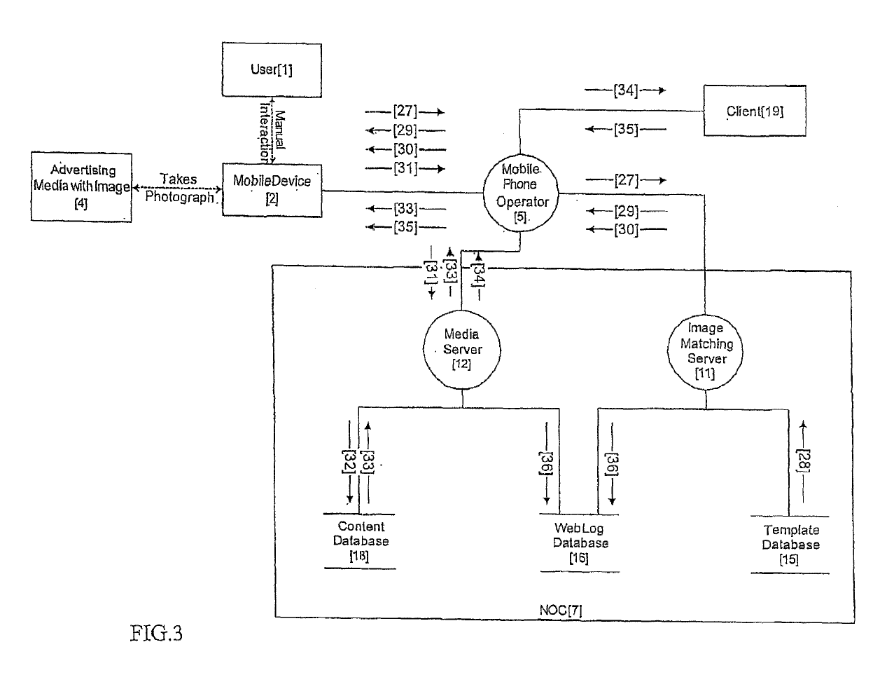

FIG. 3 illustrates in more detail the exact steps that may take place in operation of the embodiment of FIG. 1. As discussed above to begin with a user 1 activates any necessary software and uses his or her mobile phone 2 to take a photograph of a selected image 3 located within advertising material 4. The image 3 is preferably photographed so that it almost fills the screen of the phone. The application software may guide a user 1 appropriately to ensure that the image is properly captured. Application software on the mobile phone 2 then processes the captured image by conversion to grayscale followed by extraction of image data, and the extracted image data is then sent over the mobile phone network of operator 5. It should be noted that the file size of the extracted image data is substantially smaller than the size of the original photograph (it may be as small as 1 kB), which substantially simplifies the sending of the extracted image data.

The extracted image data is then sent (dataflow 27) (using the HTTP command of J2ME) via the Internet gateway of the mobile phone operator 5 to an image matching server 11 provided at the network operations center 7. In addition to the extracted image data, also sent in dataflow 27 is user-specific data such as number of the mobile phone 2, the type of mobile phone 2 being used, and the IP address of the Internet gateway. The image matching server 11 then compares the extracted image data 3 with the image data stored in the image database (dataflow 28) until a match is found. If no match is found an error message is sent back to the user 1 (dataflow 29) and the user may either be prompted to retake the photograph or to exit the application, but if a match is found the URL where the associated content may be found is then sent to the user 1 (dataflow 30).

When the dataflow 30 is received by the user 1, the user 1 will receive the URL address(es) from where the content may be obtained and the mobile phone 2 will activate its in-built browser and will access the URL address(es) (dataflow 31). If the content is stored at the network operations center 7 the content will be obtained from the content database 18 and then supplied from the network operations center to the user 1 (dataflow 32,33) and will be displayed on the screen of the mobile phone 2. If the content is not provided at the network operations center 7, the data will be obtained from the client 19 and supplied to the mobile phone 2 for display (dataflows 34,35).

The content provided to a user may also include the possibility of further data which may be provided at later times in push WAP, SMS or MMS format. The content provided to a user may include the option for a user to accept or decline such further content. If such later content is accepted by a user it will be scheduled by media server 12 in network operations center 7 and provided at the scheduled times.

One advantage of the present invention, at least in its preferred forms, is that a client may be provided with information relating to the number of times that the associated content has been provided and which information may assist a client in determining the effectiveness of an advertising campaign. In that regard every time that a user accesses the system and an image match is found or a URL is accessed, details of the user and the image match are saved in a web log database 16 in the network operations center (dataflow 36).

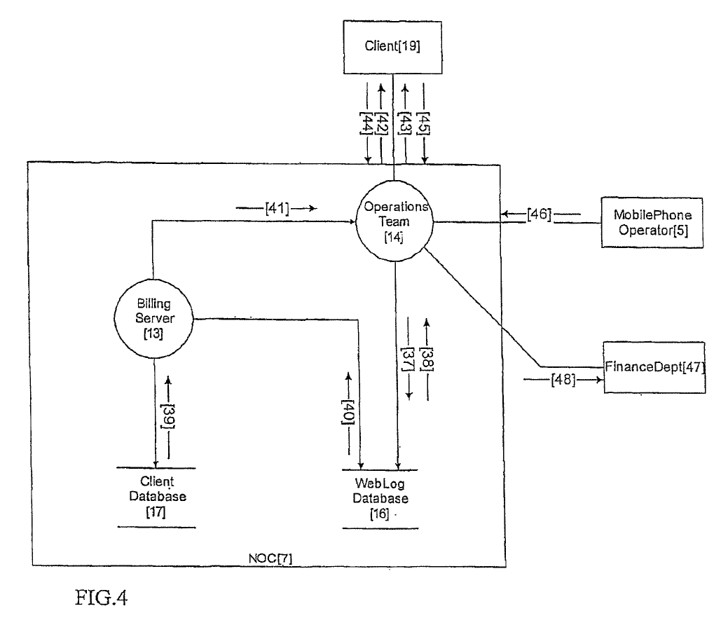

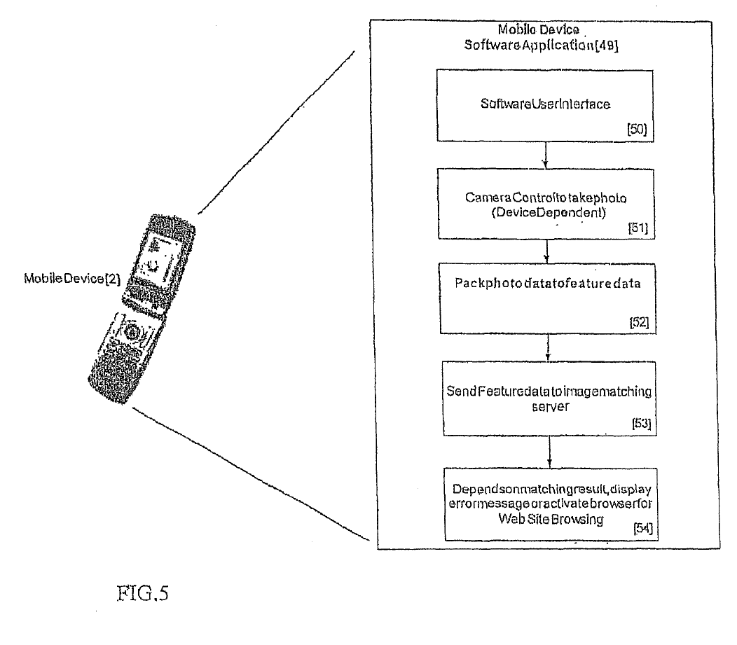

FIG. 4 shows how clients 19 may be billed for their use of the content distribution system, and further shows how clients may be provided. with usage reports. In particular, with regard to usage/access reports at suitable intervals the operations team 14 will query the web log database 16 (dataflows 37, 38) to obtain usage/access reports to send to the client (dataflow 43). The client 19 may also request an ad hoc report at any time (dataflow 45) which will cause the operations team 14 to access the web log database 16 as described above. As well as simple reports based on the user mobile phone number and the URLs accessed, reports may also include geographical and demographic data concerning the users obtained from the mobile phone operator 5 (dataflow 46) subject to contractual and privacy obligations.

Still referring to FIG. 4 billing of clients is handled by billing server 13. At intervals or at other times as agreed with a client 19, the billing server 13 will query the client database 17 to obtain client billing details (dataflow 39) and will also query the web log database 16 to obtain usage statistics (dataflow 40). The billing server 13 will then calculate a bill based upon usage (or other parameters as agreed upon) and the completed bill will then be sent to the operations team 14 for checking before sending to the client 19 (dataflow 42) with a copy to a finance department 47. Billing inquiries raised by the client 19 (dataflow 44) may be handled by the billing server 13.

FIG. 5 explains in more detail the software applications 49 that are loaded on the mobile phone 2. The software applications on the mobile phone 2 include user interface 50, camera control software 51, photo data pack module 52, transmission module 53, and output module 54. User interface 50 serves as a basic interface for a user 1 who wishes to use an embodiment of the invention to obtain targeted information. Camera control software 51 will be provided with the mobile phone 2 and will be specific to the mobile phone. Photo data pack module 52 comprises software that functions to take the image captured by the mobile phone and to process the image by converting the image to grayscale and then to extract the image data into a format and size suitable for transmission. Transmission module 53 then functions to transmit the extracted image data to the image matching server 11. Finally, output module 54 functions to display either an error message (in the event of unsuccessful image matching) or to initiate a browser to obtain content. It will be understood that all necessary software may be preloaded on a mobile phone, or may be downloaded by a user who wishes to be able to use the system of the present invention. An automatic software update function may also be included in the software so that later versions of the software can be downloaded if desired.

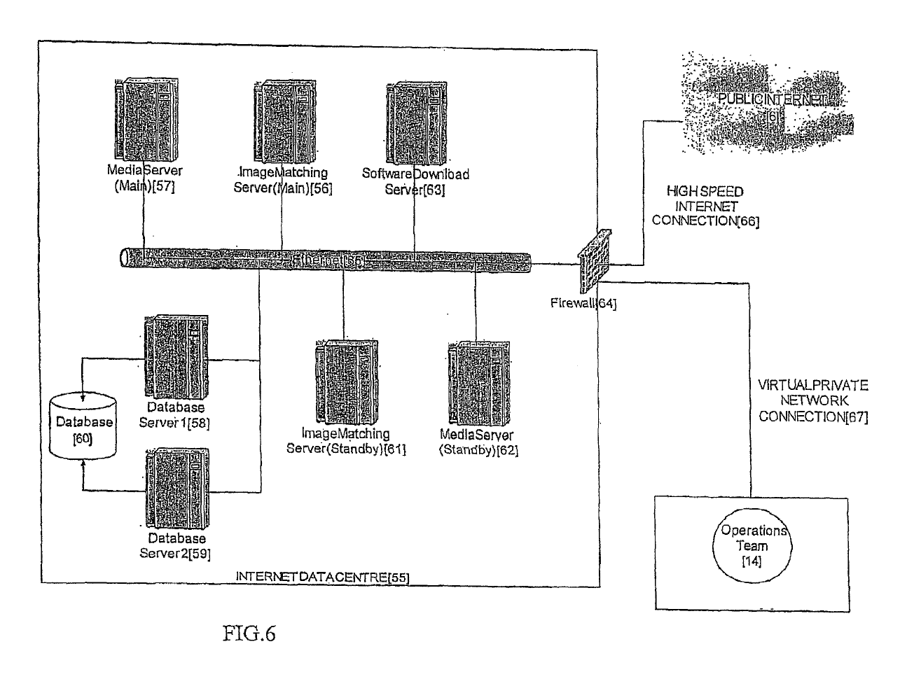

FIG. 6 illustrates one possible example of a physical network implementation of an embodiment of the invention. All necessary server systems are incorporated in an Internet data center 55 that provides a controlled and monitored environment. Data center 55 is connected to the public Internet 6 through a high-speed connection 66 and a firewall 64 is provided for protection of the data center 55. Data center 55 comprises a number of servers all connected via an Ethernet local area network 65. These servers include image matching server 11 together with a back-up standby image matching server 11a, media server 12 (which costs the content database 18) and back-up standby media server 12a. Standby servers 11a, 12a are provided in case of failure of image matching server 11 and media server 12. Media software download server 63 is provided to enable users to access software downloads and upgrades as required.

Client database 17, web blog database and image database 15 are critical databases and are therefore preferably implemented by two database servers 58, 59 operating as a cluster.

The Internet data centre 55 is connected to the operations team 14 by means of a virtual private network connection 67. It will of course be understood that the operations team 14 may be located physically proximate the Internet data centre 55, or may be located remote therefrom. It will similarly be understood that while in the embodiment of FIG. 6 the various servers are located together in a single Internet data centre, they could be located in different physical locations provided that they are functionally connected together.

As mentioned above the operations team 14 may comprise human operators and/or software means. The operations team 14 largely functions as an interface between the system and a client 19 and many of the interface functions could be done automatically. For example, with reference to FIG. 2 the registration of a new client 19 could be performed by the client performing registration steps at a system website, new campaigns may be added automatically, templates downloaded and new content uploaded. Similarly, in FIG. 4 a client may obtain reports, billing and account information and the like through a system website.

The present invention, at least in its preferred forms, has a number of advantages, not least being the ability to provide a realtime response (either provision of content or a failure message).

Other advantages include, for example, that it may be possible for a user to pay for products or services using their mobile phone and an embodiment of the present invention. Payment by credit card, debit card, stored value card, or other forms of pre- and post-payment may be associated with the image matching and server systems may be incorporated in the system to interface with relevant financial institutions. The incorporation of using mobile phone for payment using an embodiment of the present invention requires commercial agreements and technical integration between the operators of the system and the financial institutions. In order for a user to use this service, the user must first register an account with the system providing certain specific personal details together with their preferred payment method for settling such an account, such as credit card or direct debit. Once the user's account is verified and accepted the user may pay for products or services using their mobile phone and an embodiment of the present invention.

One example of using mobile payment with the present invention is when a user takes a photograph of an image of a product featured in an advertising material and wishes the purchase the product through the mobile phone. If the image match is found in the image database and user wishes to purchase the product, the user may add the selected product to a “shopping cart” similar to those found on online shopping websites. Once the user is satisfied with their selection in the shopping cart the user may confirm to make payment. Depending upon the value of the purchase and the agreements with particular financial institutions, there may be differing levels of security on the purchase varying from simply recognizing the user's mobile number to confirming mobile number, user name and a password. The system authorises the payments in real time and the transactions will either clear in real time or in daily batches as my be agreed with the financial institutions. Other features of the mobile payment include processing of any blacklist or whitelist information that may be required from financial institutions as well as applying its own blacklist and whitelists should it be necessary. In order to preclude any communications failure with the mobile phone causing transactions to be applied, a transaction will not be deemed successful (and therefore not passed to the clearing organization) until and unless all activities associated with that transaction have been processed and received by the system. A further feature, subject to relevant agreements with mobile operators is that mobile payments transactions may be routed to the users mobile telephone bills.

Further a loyalty program may be an additional feature of the present invention. A loyalty program will allow users to acquire points (or any other means of recording the value of a transaction) accumulated through purchases related to the present system. Once a user has registered with the loyalty program, the system will track purchases made by the user and associate points for purchases of products included in the loyalty program. For example, clients who wish to implement the loyalty program could provide an image to the user accompanying a purchase of the client's product. The image could be on the product packaging itself, as a separate leaflet within the packaging or handed to the user at the point of sale by sales staff. The user would use the mobile phone to take a photograph of the image and submit the image. The points (or any other means of recording the value of the transaction) will be associated with the user. For purchases of client's products using mobile payments as described above, the users registered with the loyalty scheme would automatically receive points associated with those purchases. The user may browse their current balance of loyalty points plus have the ability to select and redeem any rewards related thereto. Clients would also be able to process account data pertaining to the loyalty program accounts of users and perform data mining thereon to produce reports on purchase habits, brand loyalty, individual sales campaign results, customer demographics, etc.

Content provided to a user may be personalized dependent on their past history of accessing the system as stored in the web log database, and the user can of course bookmark pages for later viewing using the mobile phone browser or using the software which allows a user to create a bookmark of addresses to be stored on the web log database. By using the bookmark feature of the software, the user can view the bookmarks by retrieving their current list of bookmarks from the server to display on their mobile phone. After selecting the bookmark that the user wishes to view, the relevant content is displayed and directly launched in the mobile phone's browser without having to do any image matching. The user may be able to configure their mobile phone to view their bookmark in a number of ways, including but not limited to: most recent, most popular, alphabetical, by category, etc. There may also include the possibility of automatic addition of bookmarks that are considered to be of interest to a user based on the history of accessing the system and/or the existing bookmarks created by the user. Users also have the option of opting out of any automatic addition of bookmarks.

The information provided to a user can of course be customized depending on the model of the mobile phone used. It may also be noted that if a user attempts to download the necessary application software to a mobile phone not yet supported by that software, the system may record that attempt and may push the necessary software to the mobile phone at a later date when it becomes available.

Another possibility exists which is that a user may download the software to a mobile phone that for various reasons cannot use the system as described above. This may be for a number of possible reasons. For example the mobile phone may have a camera that may not be controllable by the software midlet, or may have a camera the resolution of which is insufficient to allow it to be used with the above described embodiments of the invention, or may have no camera at all. A further difficulty is that some mobile phones may fail to report their mobile number when using the system as described above and for some applications such as lucky draws and coupons the mobile number is important. For such cases the software midlet may be modified to allow the system to be used with such mobile devices.

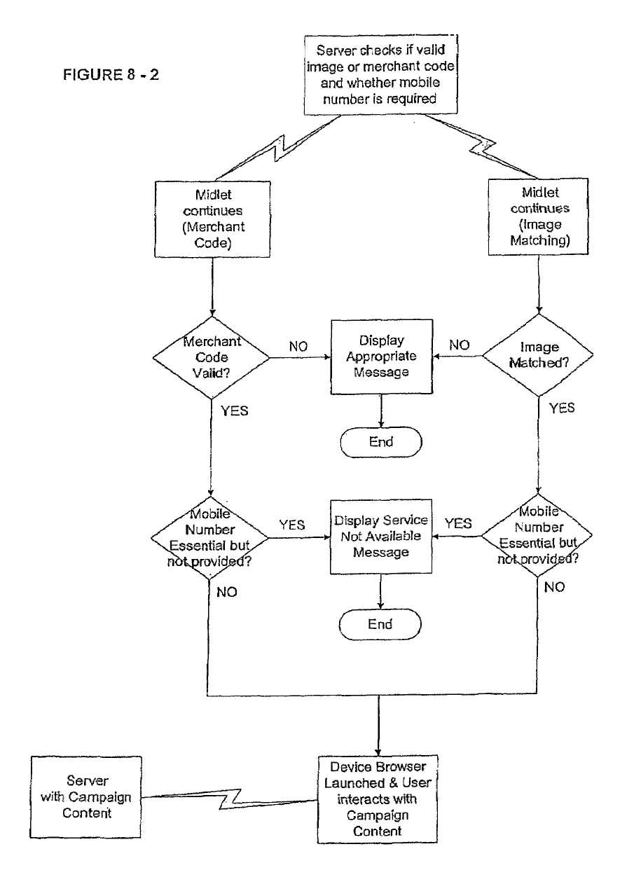

FIG. 8 shows an example of how the software midlet may be modified to implement this alternative embodiment. When the midlet is started by a user, the midlet communicates with the server which hosts a list of mobile phones (and similar mobile communication devices) that are certified as being usable with the abovedescribed embodiment of the invention and a check is performed to see if the mobile phone is on this list of certified devices, and also to check that a mobile number has been provided.

If the mobile phone is certified as being suitable for use with the abovedescribed system a display screen is presented to a user to prompt the taking of a photograph, if a user takes a photograph this is then processed as described above and the image data is sent to the server for image matching as previously described. If at the beginning of this process the check has revealed that no mobile number was sent, then the user may receive a display screen indicating that certain services are unavailable, though services not requiring a mobile number will still be available.

Alternatively, if the initial check determines that the mobile phone is not certified for use with the abovedescribed system, the user is instead presented with a screen for entering a merchant code. The merchant code may be any alphanumeric code that will be printed on an advertisement or similar adjacent to the image that would be photographed and at the server the alphanumeric codes are stored in the image database in a searchable manner linked with their associated images. Each alphanumeric code is unique to a particular image. A user may then enter the merchant code which will be sent to the server. The server will then match the code with the codes stored and—assuming that a valid code is entered, if not an appropriate message is displayed—will provide the associated content. As with image matching, certain services may be unavailable if the original check has indicated that no mobile number was provided.

It will of course be understood that the option of providing a code in place of the extracted image data where a communications device is not suitable for use with systems requiring the photographing of an image and the transmission of an image or image data is an option that has wider applications and may also be used in combination with other systems and methods for providing data in response to the transmission of an image or data extracted therefrom and not only the system and method described above. Similarly the check to see if a mobile number has been received and if not restricting the number of services that may be available can also be used with other systems and methods and not only the system and method described above.

It will also be understood that while the system described above is in the context of a mobile telephone network using 2.5G and 3G data services, the system could also be implemented with a mobile device that communicated through other communication protocols including Bluetooth or Infra-red connections to a PC or similar terminal that has Internet connectivity.

It will also be understood that while the description above has been in the context of advertising material and associated content, the nature of both the material in the print media and the associated content may take other forms and need not be commercial advertising. Commercial and non-commercial possibilities, for example, include: display of television commercials, playing of audio/visual clips and advertisements, display of video demonstrations, display of music videos, access to online menus, display of tutorials and “how to” videos, playing of trailers for films and events, display of sales and marketing videos, display of property information, displays of restaurant information, access to pay-per-view TV, booking and purchase of tickets for travel or events, provision and redemption of coupons, access to directories, display of maps and directions to local sights and places, display of particular store or branch locations, to garner discounts for browsing for particular products, to gain access to credit card promotions, to participate in lucky draws, to obtain downloads, to purchase products and services online, to top up items such as stored value cards and SIM cards, to participate in online auctions, to make reservations for travel and accommodation, accessing hotlines and customer services, to sign up to receive SMS or MMS programs and newsletters, to access online voting, to access celebrity websites and blogs, to find exhibitors in an exhibition, and controlled access to gaming and adult content.

1. A system for providing data content to a user, comprising:
(a) a communications device and a camera, said camera being capable of taking a photograph of an image and said communications device being capable of processing said photograph to extract image data and to transmit said extracted image data,
(b) an image database comprising image data associated with a plurality of different images,
(c) a content database comprising data content associated with respective said images,
(d) means for receiving extracted image data transmitted from a said communications device and means for matching said extracted image data with image data stored in said image database, and
(e) means for transmitting to said communications device data content associated with a respective image when a match between said extracted image data and stored image data is made.

2. A system as claimed in claim 1 wherein said data content transmitted to said communications device includes data to be displayed on a screen of said communications device.

3. A system as claimed in claim 1 wherein said data content transmitted to said communications device includes an address from where data may be obtained by said communications device.

4. A system as claimed in claim 3 wherein said data content includes instructions for said communications device to activate a browser program and to obtain said data from said address.

5. A system as claimed in claim 1 further comprising a usage database for storing details of users who access the system and the Images transmitted by said users.

6. A system as claimed in claim 5 wherein said usage database stores a list of addresses bookmarked by said users.

7. A system as claimed in claim 6 further comprising means for adding addresses to said list of bookmarked addresses based on said details of users in said usage database.

8. A system as claimed in claim 6 further comprising means for transmitting said list of bookmarked addresses to said communications device.

9. A system as claimed in claim 5 further comprising means for generating reports from said usage database.

10. A system as claimed in claim 1 including means for uploading new image data and new associated content to said image and content databases.

11. A system as claimed in claim 1 wherein said matching means comprises a software image matching program and wherein associated data is provided to a user in the event of a successful match being found by said program, and wherein an error message is provided to said user in the event of no match being found.

12. A system as claimed in claim 1 wherein said data transmitted to said communications device includes an option for a user to receive further data at future times.

13. A system as claimed in claim 11 further comprising means for purchase of an item or service which is associated with said image, in the event of a successful match being found by said program, using said communications device.

14. A system as claimed in claim 13 wherein payment for said purchase is made using said communications device.

15. A system as claimed in claim 13 wherein details of said purchase are stored in said usage database.

16. A system as claimed in claim 15 wherein said purchases made by users are associated with points which can be accumulated by users to use in a loyalty program.

17. A system as claimed in claim 1 wherein said communications device and said camera are formed by a mobile communications device with an integral camera.

18. A system as claimed in claim 17 wherein said mobile communications device is a mobile phone.

19. A system as claimed in claim 18 wherein means are provided for checking that the mobile phone has provided its mobile phone number to the system and for providing only limited access to the system if no number is provided.

20. A system as claimed in claim 18 wherein said extracted image data is transmitted from said mobile phone to the Internet gateway of a mobile phone network and then through the Internet.

21. A system as claimed in claim 1 wherein said image data stored in said image database corresponds to images presented in two-dimensional visual media.

22. A system as claimed in claim 1 wherein said photographed image is converted to a grayscale image prior to extraction of image data.

23. A system as claimed in claim 22 wherein said image data comprises data relating to the number of pixels per grayscale frequency.

24. A system as claimed in claim 1 further comprising means for determining whether a said communications device is capable of extracting and sending image data, and wherein in the event that a said communications device is not capable of extracting and sending image data a user is presented with means for entering an alphanumeric code associated with said image for transmission in place of extracted image data, said system comprising a database of alphanumeric codes, each said alphanumeric code in said database being associated with content in said content database, and wherein in the event of a said transmitted alphanumeric code being matched with an alphanumeric code in said code database said associated content is transmitted to said communications device.

25. A method of providing data content to a user, comprising:
(a) receiving image data extracted from a photographed image and transmitted by a user from a communications device,
(b) comparing said extracted image data with image data stored in an image database, and
(c) in the event of an image match being found transmitting to said communications device data content associated with said photographed image.

26. A method as claimed in claim 25 wherein said data content transmitted to said communications device includes data to be displayed on a screen of said device.

27. A method as claimed in claim 25 wherein said data content transmitted to said communications device includes an address from where data may be obtained by said communications device.

28. A method as claimed in claim 27 wherein said data content includes instructions for said communications device to activate a browser program and to obtain data from said address.

29. A method as claimed in claim 25 further comprising storing in a usage database details of users transmitting extracted image data and details of the images associated with said transmitting extracted image data.

30. A method as claimed in claim 29 wherein said usage database stores a list of addresses bookmarked by said users.

31. A method as claimed in claim 30 further comprising means for adding addresses to said list of bookmarked addresses based on said details of users in said usage database.

32. A method as claimed in claim 30 further comprising means for transmitting said list of bookmarked addresses to said communications device.

33. A method as claimed in claim 29 further comprising generating reports from said usage database

34. A method as claimed in claim 25 wherein an error message is delivered to said user in the event that no match is found between said transmitted extracted image data and the image data stored in said image database.

35. A method as claimed in claim 25 wherein said data transmitted to said communications device includes an option for a user to receive further data at future times.

36. A method as claimed in claim 25 further comprising means for purchase of an item or service which is associated with said image, in the event of a successful match being found by said program, using said communications device.

37. A method as claimed in claim 36 wherein payment for said purchase is made using said communications device.

38. A method as claimed in claim 37 wherein details of said purchase are stored in said usage database.

39. A method as claimed in claim 38 wherein said purchases made by users are associated with points which can be accumulated by users to use in a loyalty program.

40. A method as claimed In claim 25 wherein said extracted Image data IS transmitted wirelessly.

41. A method as claimed in claim 40 wherein said communications device is a mobile communications device.

42. A method as claimed in claim 41 wherein said mobile communications device comprises a mobile phone with an integral camera, wherein a photographed image is processed on said mobile phone to extract image data, and wherein extracted image data is transmitted from said mobile phone to the Internet gateway of a mobile phone network and then through the Internet.

43. A method as claimed in claim 25 wherein said image data stored in said image database correspond to associated images printed in two-dimensional visual media.

44. A method as claimed in claim 25 wherein a determination is made as to whether a said communications device is capable of extracting and sending image data, and wherein in the event that a said communications device is not capable of extracting and sending image data a user is presented with means for entering an alphanumeric code associated with said image for transmission in place of extracted image data, said system comprising a database of alphanumeric codes, each said alphanumeric code in said database being associated with content in said content database, and wherein in the event of a said transmitted alphanumeric code being matched with an alphanumeric code in said code database said associated content is transmitted to said communications device.

45. Apparatus for providing data content to users, comprising:
(a) means for receiving extracted image data from a user,
(b) means for comparing said extracted image data with image data stored in
an image database,
(c) a content database hosting data content associated with respective images associated with the image data stored in said image database, and
(d) means for transmitting to a user data content associated with an image in the event that said extracted image data matches image data in said image database.

46. Apparatus as claimed in claim 45 further comprising means for uploading new data content to said content database, and/or new image data to said image database.

47. Apparatus as claimed in claim 46 further comprising a usage database for recording details of users and details of image data received from users.

48. Apparatus as claimed in claim 47 wherein said usage database further records a list of addresses bookmarked by said users.

49. Apparatus as claimed in claim 47 wherein said databases are hosted on at least one server.

50. Apparatus as claimed in claim 49 comprising a media server for hosting said content database, at least one database server for hosting said image database and said usage database, and an image matching server for performing said step of comparing received extracted image data with image data in said image database.

51. Apparatus as claimed in claim 50 wherein a second media server and a second image matching server are provided as back up.

52. Apparatus as claimed in claim 50 wherein said at least one database server comprises two database servers operating as a cluster.

53. Apparatus as claimed in claim 50 further comprising a software download server.

54. Apparatus as claimed in claim 45 wherein said means for receiving extracted image data from a user includes an Internet connection.

55. A method of obtaining data associated with an image, comprising:
(a) photographing said image,
(b) extracting image data from said photograph,
(c) transmitting said extracted data by means of a communications device to an image matching server, wherein said server hosts an image database comprising image data associated with a plurality of respective images, and
(d) in the event of a match receiving data associated with said image.

56. A method as claimed in claim 55 wherein said image data is extracted by firstly converting the photographed image to a grayscale image, and then extracting data relating to the number of pixels per grayscale frequency.

57. A system for providing data content to a communications device in which said communications device sends data to a server and wherein said server transmits data content to said communications device in reply, wherein means are provided at said server for determining whether or not said communications device is capable of taking a photograph of an image and transmitting said image or data extracted therefrom to said server, and wherein dependent on the result of said determination a user may either take a photograph of an image and send said image or data extracted therefrom to a server or a user may send an alphanumeric code associated with said image in place of said image or data extracted therefrom if the communications device is not able to either take a photograph and/or transmit said image or data extracted therefrom.
